(19) United States
(12) Patent Application Publication
(10) Pub. No.: US 2002/0198628 A1
(43) Pub. Date: Dec. 26, 2002

(54) Apparatus and method for error prevention and pathfinding

(76) Inventors: Yim Kwong Ng, Ontario (CA); Paul D. McDonald, Ontario (CA); Johanne Penington, Ontario (CA); David M. Cormier, Ontario (CA); Malcolm Betts, Ontario (CA)

Correspondence Address: NORTEL NETWORKS LIMITED, P. O. BOX 3511, STATION C, OTTAWA, ON, K1Y 4H7, CA

(21) Appl. No.: 09/864,329

(22) Filed: May 25, 2001

(51) Int. Cl. G05D 3/12; G05D 5/00; G05D 9/00; G05D 11/00; G05D 17/00

(52) U.S. Cl. 700/286

(57) ABSTRACT

The present invention provides a slot identification strategy for an optical cross-connect platform which facilitates replacement or repair of field replaceable units by a servicing technician. The slot identification strategy is comprised of three components: (a) functional group naming; (b) functional group numbering; and (c) functional group colour coding. Like components are placed together in functional groups and given alpha, numeric and colour labels to ensure minimal errors when identifying and removing a specified field replaceable unit in need of servicing. In an environment which cannot tolerate errors, the identification strategy integral to the present invention maximizes a human's ability to perceive colours and alpha-numeric labels, thereby allowing a technician to quickly and accurately locate a component on the cross-connect platform.

### BACKGROUND

1. Field of Invention

The invention relates to data networking and in particular to an apparatus and method for assisting technicians with error prevention and pathfinding in an optical cross connect switch.

2. Related Prior Art

In an effort to support high bandwidth services to an increasing user base, data transport networks have become increasingly complex. Optical networks have been seen by many as the architecture which can provide the increased capacity required. As shown in FIG. 1, one such optical architecture has a user 10 connecting to an optical metropolitan area network (MAN) 12 which connects to an optical long haul network 14. In the long haul network, Dense Wavelength Division Multiplexing (DWDM) switches 16 operating in the 10 Gbps range are coupled with optical amplifiers (not shown) to provide an optical transport system that is scalable to 1.6 terabits per second over a single strand of fiber and which can transport optical signals up to 4000 km without electrical regeneration. MAN switching is accomplished by multi-rate, multi-service SONET bandwidth management platforms and open air laser systems which consist of a mesh network of rooftop nodes that communicate with each other through free-space laser beams. Additionally, a network management function 18 facilitates service assurance, customer care & billing and service activation among other services. It will be understood by those in the art that FIG. 1 represents only one optical networking solution and is not meant to restrict the present invention. The present invention is useful in any optical network which includes a cross-connect platform.

In the architecture of FIG. 1, where the MAN 10 connects to the long haul network 14, an optical cross-connect platform 20 is provided. The Nortel Networks OPTera Connect HDX Connection Manager™ is an example of such a device. It is a multi-terabit optical cross-connect platform serving a high capacity, high performance optical network. It allows interconnection of hundreds of routers, ATM and SONET/SDH switches, as well as transparent wavelength services, at rates up to 40 Gbps. Along with physical fiber connectivity, this cross-connect platform provides full management of Add/Drop, Transit as well as Pass-Through traffic.

Like optical cross-connect platforms of this type, the amount of data (and corresponding users) which are managed by the device is staggering. Typically these devices comprise a plurality of line cards with each line card supporting as many as 10,000 users. Each line card is physically connected to, among other components, a power module. Historically, the line card and power module were co-located for ease of servicing by a technician. The line cards gather optical fiber groups and cross-connect them through a midplane to switching cards located on the opposing side of the backplane. In an attempt to increase the number of fibers cross-connected while maintaining the smallest possible footprint for the cross-connect platform, it became necessary to separate the power servicing module from its associated line card. This served to free up more space on the midplane to terminate and cross-connect fiber.

However, this reconfiguration was problematic because it raised the potential for technician error when servicing the cross-connect platform. More specifically, there existed the potential for the wrong power servicing module to be shut down when a particular line card required servicing or replacement. In the event that a power servicing module was incorrectly shut down, the result would be catastrophic, given the number of users' serviced by its associated line card. This problem also existed in respect of other components positioned on optical cross-connect platform 20 which had physically separate power servicing modules. A solution was required to minimize the potential for such an error while allowing quick, error free location of the associated component to be serviced.

### SUMMARY OF THE INVENTION

The present invention serves to overcome the deficiencies of the prior art by providing a slot identification strategy which allows a technician to effectively associate a component on a optical cross-connect platform with its' differently located power servicing module. Additionally, the present invention ensures that a technician can quickly and accurately locate a component on the optical cross-connect platform which may need to be replaced.

The identification strategy is comprised of three components: (a) functional group naming; (b) functional group numbering; and (c) functional group colour coding. With respect to (a), each group of components (e.g. power service modules) on the cross-connect platform is represented by a unique alpha identifier on both the slot where the component is housed and on the component itself. With respect to (b), each functional group of components is represented by a different number series. Finally, with respect to (c), each functional group is marked with a different colour bar or graphic pattern to provide a visual cue for immediate grouping of related components. The power service module functional grouping has additional markings which identify by alpha, numeric and colour code indicators the component associated with the power service module.

In one broad aspect of the invention there is provided an optical cross-connect platform comprising: power service modules; shelf controller cards; fans; routing, synchronization and protection modules; and port cards, wherein a selected one of the power servicing modules is associated with a selected one of the shelf controller cards, fans, routing, synchronization and protection modules or port cards; and wherein the power service modules, shelf controller cards, fans, routing, synchronization and protection modules and port cards form functional groups, and wherein each power service module and its associated shelf controller card, fan, routing, synchronization and protection module or port card share at least one identifier.

In another broad aspect of the invention, there is provided in an optical cross-connect platform comprising power service modules, shelf controller cards, fans, routing, synchronization and protection modules and port cards, a method of providing error prevention and pathfinding comprising: connecting a selected one of the power service modules to a selected one of the shelf controller cards, fans, routing, synchronization and protection modules or port cards; grouping the power service modules, shelf controller cards, fans, routing, synchronization and protection modules and port cards into co-located functional groups; assigning each power service module and its associated shelf controller card, fan, routing, synchronization and protection module or port card at least one common identifier; and using the at least one common identifier, correlating a selected one of the shelf controller cards, fans, routing, synchronization and protection modules or port cards with its associated power service module.

In yet another broad aspect of the invention there is provided a method of error prevention and pathfinding in an optical cross-connect platform, the cross-connect platform comprising power service modules, shelf controller cards, fans, router, synchronization and protection modules and port cards, wherein a selected one of the power service modules is associated with a selected one of the shelf controller cards, fans, router, synchronization and protection modules or port cards, and wherein the power service modules, shelf controller cards, fans, router, synchronization and protection modules and port cards are co-located to form functional groups; and wherein each power service module and its associated shelf controller card, fan, routing, synchronization and protection module or port card share at least one identifier, the method comprising: locating a selected one of the power service modules, shelf controller cards, fans, routing, synchronization and protection modules or port cards in less than 4 seconds.

The advantages of the present are now clearly evident. Using the apparatus and method of the present invention, components within the optical cross-connect platform can be readily identified to facilitate replacement or repair by a servicing technician. Search time is reduced and the numbers of search errors are minimized. In addition, shut down of the proper power service module associated with the component to be replaced or serviced is enhanced by providing alpha, numeric and colour identifiers which provide mental triggers to the technician when correlating the component to be serviced to its associated power service module. Ergonomically speaking, the identification strategy integral to the present invention maximizes a human's ability to perceive colours and labels, thereby ensuring minimal errors in an environment which cannot tolerate errors.

### BRIEF DESCRIPTION OF THE DRAWINGS

These and other features of the preferred embodiments of the invention will become more apparent in the following detailed description in which reference is made to the appended drawings wherein:

FIG. 1 depicts a typical optical network;

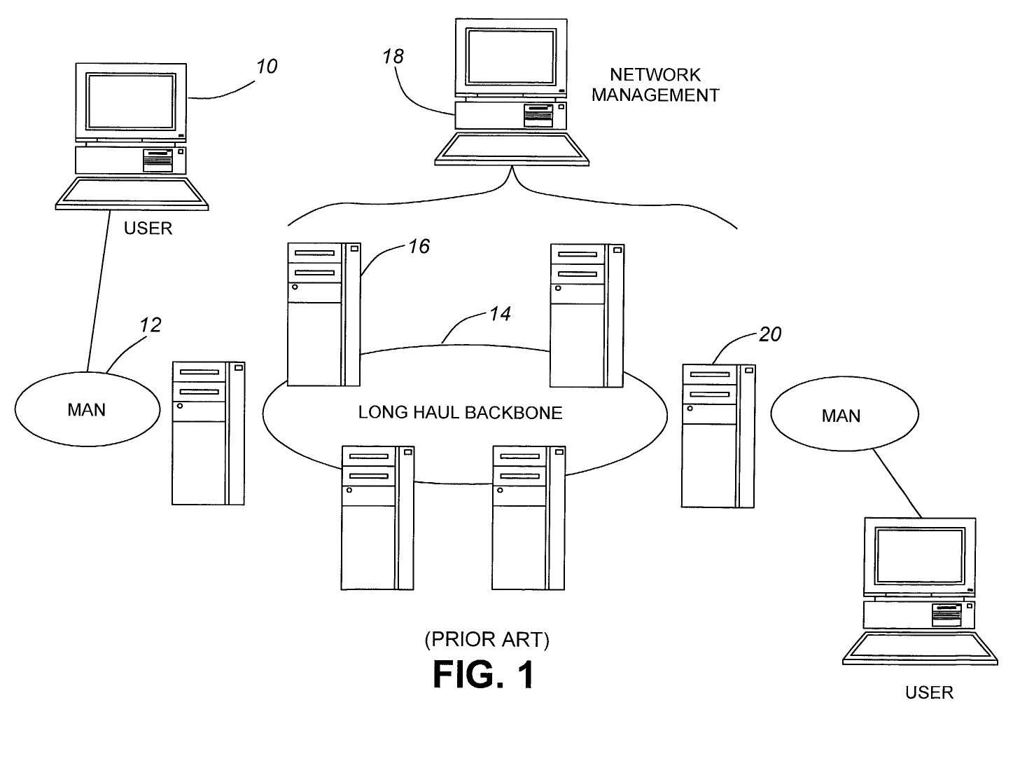

FIG. 2 depicts the port side of an optical cross-connect platform;

FIG. 3 depicts the power service module functional grouping;

FIG. 4 depicts the shelf controller card functional grouping;

FIG. 5 depicts the fan functional grouping;

FIG. 6 depicts the router, synchronization and protection module functional grouping;

FIG. 7 depicts the port card functional grouping; and

FIG. 8 depicts the switch side of an optical cross-connect.

### DESCRIPTION OF THE PREFERRED EMBODIMENT

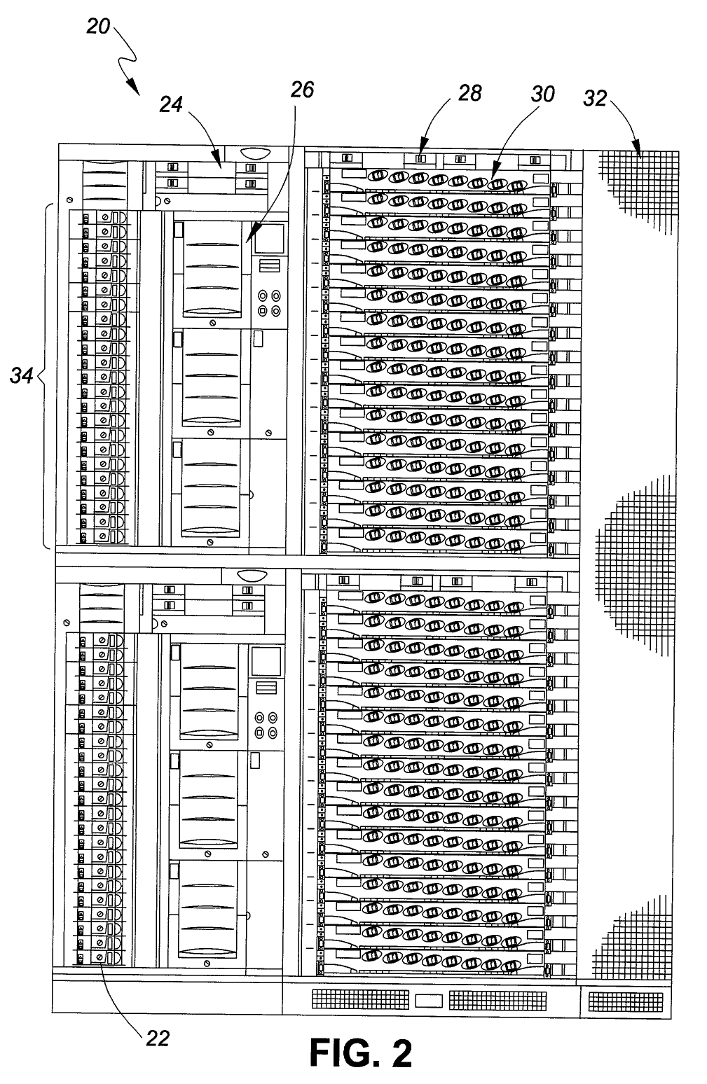

Referring to FIG. 2, the port side of an optical cross-connect platform 20 is depicted. The port side comprises power service modules (PSM) 22, shelf controller cards (SC) 24, fans 26, routing, synchronization and protection modules (RSP) 28 and port cards 30. Additionally, fiber management trays 32 may be included. Similar components are placed together to form a functional group (e.g. power service module functional grouping 34) the purpose of which we will be described later. As will be appreciated by those skilled in the art, each the components discussed above are separately housed in a bay or slot to facilitate easy removal, replacement and/or repair. Generically, such components are referred to as field replaceable units (FRU). As will also be appreciated by those skilled in the art, a selected one of the power service modules serves as the power source of an associated SC 24, fan 26, RSP 28 or port card 30.

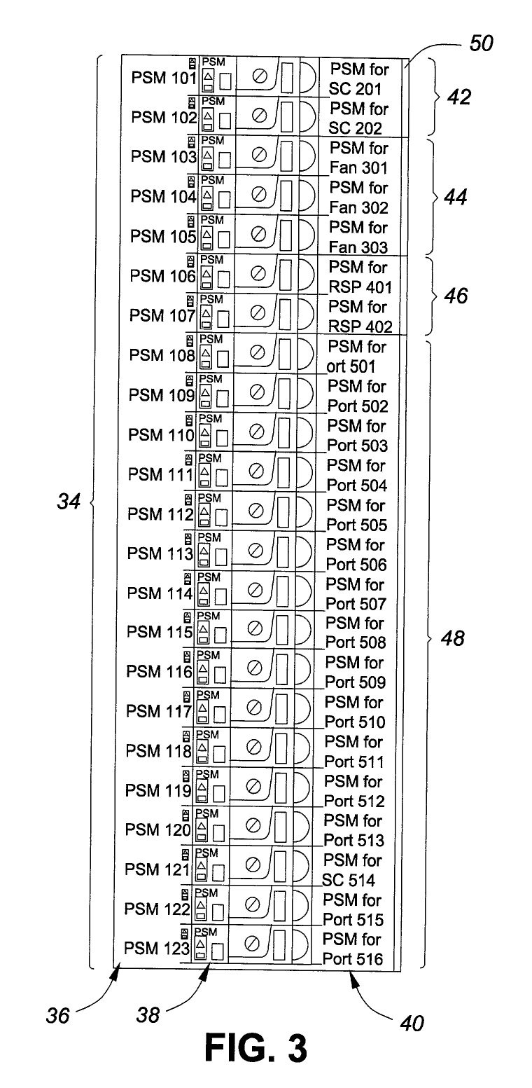

Referring to FIG. 3, the power service module functional grouping 34 is shown. In this functional grouping each of the slots housing the power service modules are given an alpha and numeric label, generally depicted at 36. More specifically, each slot is assigned a consecutive number beginning at number 101 and each slot is also labeled with the generic acronym “PSM”. This generic acronym is also indicated on the actual power service module as shown generally at 38. To facilitate correlation between a selected PSM 22 and its associated SC 24, fan 26, RSP module 28 or port card 30, additional labeling has been provided, as depicted generally at 40. Each of the PSMs 22 associated with an SC 24, fan 26, RSP 28 or port card 30 functional grouping are placed together in sub-groups as indicated at 42, 44, 46 and 48 respectively. Each of these sub-groups are given alpha, numeric and colour identifiers, specifying the specific component within a functional group with which the PSM 22 is associated e.g. the PSMs 22 associated with shelf controller card functional group are identified using a red bar 50, a number (i.e. 201 to 203), and the acronym associated with the shelf controller, SC. The colours assigned to the sub-groups are red, blue, brown and purple for the SCs, fans, RSP and port cards respectively. It will be understood by those skilled in the art that the colour combination may be varied without departing from the scope of the invention. Any colour combination in which each functional group is distinctive and visually captivating will suffice. It will also be understood by those skilled in the art that the alpha and numeric slot label may be combined with the functional group labeling to provide a combined label e.g. PSM 101 for SC 201 with a red colour bar would serve to identify PSM 101 and the PSM associated with SC 201.

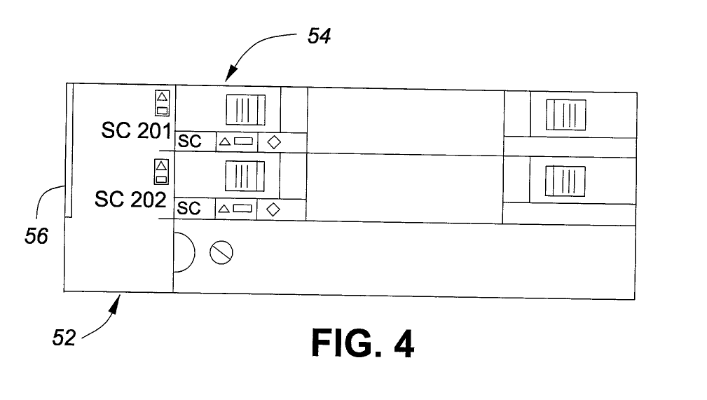

FIG. 4 depicts the shelf controller card functional grouping. As shown in the drawing, the slots housing the shelf controller cards are given an alpha and numeric label, generally depicted at 52. More specifically, each slot is assigned a consecutive number beginning at number 201 and each slot is also labeled with the generic acronym “SC”. This generic acronym is also indicated on the actual shelf controller card as shown generally at 54. Finally, there is a red bar 56 which is the unique colour code assigned to the shelf controller card functional grouping

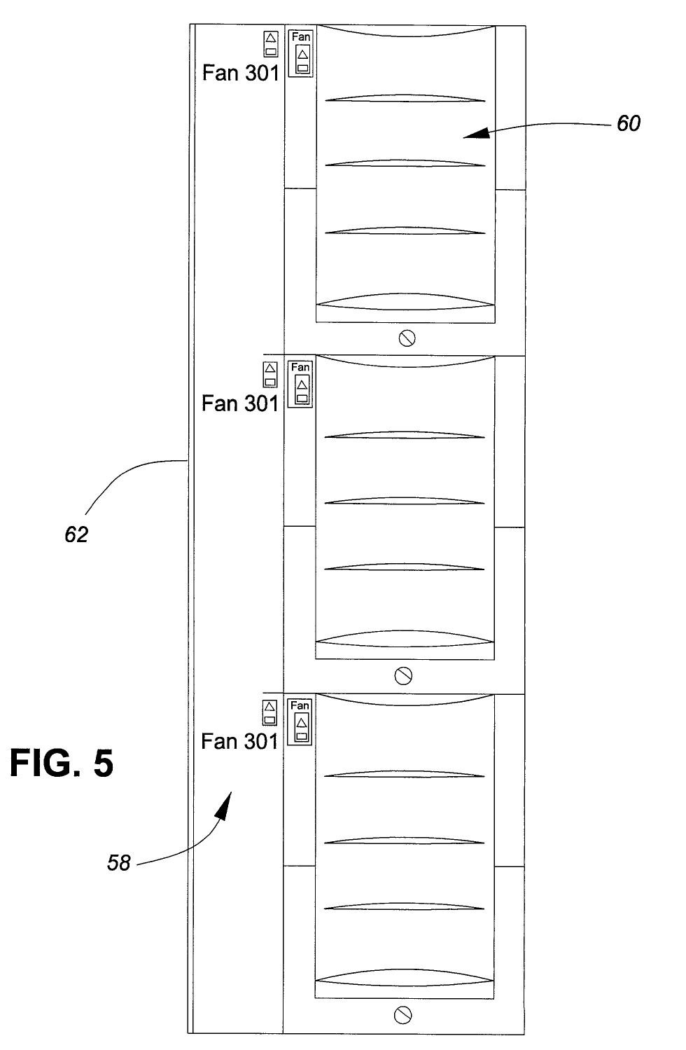

FIG. 5 depicts the fan functional grouping. As shown in the drawing, the slots housing the fans are given an alpha and numeric label, generally depicted at 58. More specifically, each slot is assigned a consecutive number beginning at number 301 and each slot is also labeled with the generic label “Fan”. This generic label is also indicated on the actual fan as shown generally at 60. Finally, there is a blue bar 62 which is the unique colour code assigned to the fan functional grouping.

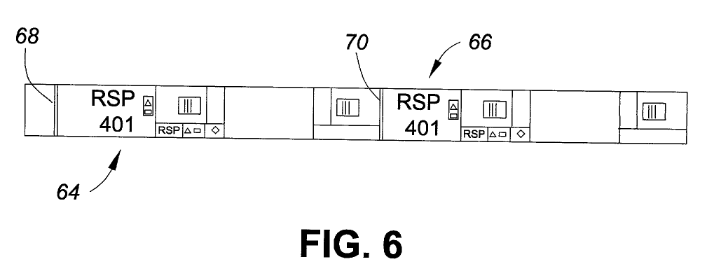

FIG. 6 depicts the routing, synchronization and protection (RSP) module functional grouping. As shown in the drawing, the slots housing the RSP modules are given an alpha and numeric label, generally depicted at 64. More specifically, each slot is assigned a consecutive number beginning at number 401 and each slot is also labeled with the generic acronym “RSP”. This generic acronym is also indicated on the actual RSP module as shown generally at 66. Finally, there are the brown bars 68, 70 which represent the unique colour code assigned to the RSP module functional grouping.

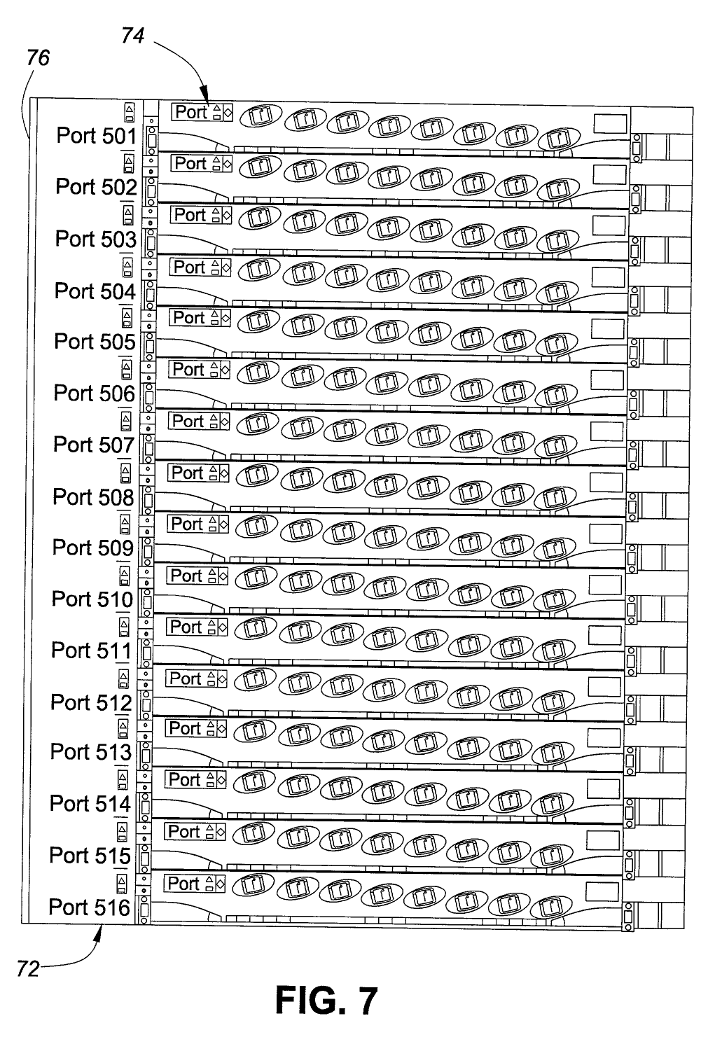

FIG. 7 depicts the port card functional grouping. As shown in the drawing, the slots housing the port cards are given an alpha and numeric label, generally depicted at 72. More specifically, each slot is assigned a consecutive number beginning at number 501 and each slot is also labeled with the generic label “Port”. This generic label is also indicated on the actual port card as shown generally at 74. Finally, there is a purple bar 76 which is the unique colour code assigned to the port card functional grouping

Looking at optical cross-connect platform 20 in its entirety, it can be seen that the functional groupings are labeled using the numbering series 100 to 500 which are read from left to right and top to bottom. That is to say that as the PSM functional group is given 100 series numbers, the SC card functional group is given 200 series numbers, the fan functional group is given 300 series numbers, the RSP module functional grouping is given 400 series numbers and the port card functional group is given 500 series numbers. In addition to the identification strategy used in each functional group, the overall layout and numbering scheme of the functional groups also facilitates quick and error free location of a particular component by a technician by presenting the labeling information in a manner which corresponds to text presented on the page of a book in the English language.

In operation, when the Network Operations Center determines that a specific FRU requires replacement, they notify the appropriate field technician. The technician uses the page-like layout of the optical cross-connect labeling along with the three identification layers to quickly scan the cabinet and locate the FRU to be serviced. For example, if “Fan 301” were to be replaced, the technician would be quickly directed to the fan functional grouping using the blue colour indicator and the generic “Fan” label positioned on each fan FRU. Once the technician had been directed to the functional grouping, they would identify the specific fan to be removed using the alpha and numeric “Fan 301” label provided on the slot housing the unit.

In most cases, prior to removing a component for observation the power service module associated with the component is shut off. Using the present invention, the technician is first directed to power service module functional grouping using the generic acronym “PSM” positioned on each power supply module FRU. After having located the functional grouping, the technician would then locate the specific power service module associated with the component (SC, fan, RSP or Port Card) to be removed using the alpha, numeric and colour code associated with the specific power service module e.g. “PSM for fan 301” label highlighted with a blue line, as described in relation sub-group 44 of FIG. 3.

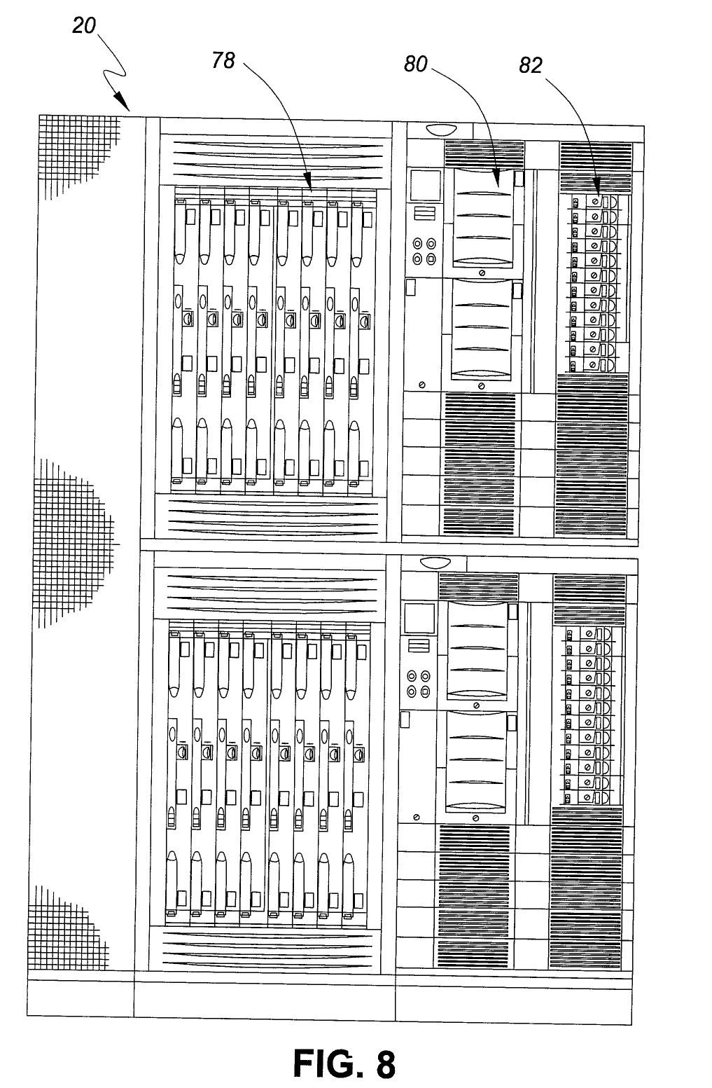

In addition, the identification strategy integral to the present invention may be used on the switch side of optical cross-connect platform 20. As shown in FIG. 8, the switch side comprises a switch card functional grouping 78, a fan functional grouping 80 and a power service module functional grouping 82. The numeric labeling on the front would be continued on the rear side with the switch card functional grouping being assigned 600 series numbers, the fan functional grouping being assigned 700 series numbers and the power service module functional grouping being assigned 800 series numbering. Alternately, the series numbers could range from 100 to 300. In addition to the series numbering, the switch card functional grouping 78 and the fan functional grouping 82 would be assigned respective uniquely coloured bar identifiers. All functional groupings would have unique alpha and numeric identifiers positioned on a respective component slot, with the alpha identifier positioned on the associated component e.g. “Switch 601” would appear beside the first switch card with “Switch” indicated on the first switch card; “Fan 701” would appear beside the first fan with “Fan” indicated on the first fan unit; and “PSM 801” would appear beside the power service module with “PSM” indicated on the first power service module. Similar to the front side, the individual components of the switch card and fan functional groupings could be correlated to a specific power service module by grouping the power service modules into switch card or fan sub-groups, and providing each power service module with unique alpha, numeric and colour identifiers e.g. “PSM for Fan 701” would be listed against “PSM 801” and contained within the fan sub-group bordered by a blue bar.

Tests were conducted with both inexperienced and experienced technicians, where participants were asked to locate specific slots identified by the tester. Participants were advised that the optical connect platform had two sides: a “Port side” and a “Switch Side”. For the Port Side, two possible panel arrangements A and B were provided while for the Switch Side, three possible panel arrangements C, D and E were provided. For each panel arrangement, four testing sequences were identified to participants. For example, on Panel A, the first testing sequence was as follows:

| | | | |
|---|---|---|---|
| | Elapsed | Done | |
| Slot Location Task | Time | Correctly | |
| Panel “A” (Port Side) | (Seconds) | (✓or X) | Comments |

Fan, 303
Power Service Module, 101
Port card, 512
Shelf Controller, 201
RSP Module, 402
Power Service Module, 122
Port card, 501
Shelf Controller, 202
Power Service Module, 107
Port card, 516
Fan, 301
Power Service Module, 112
RSP Module, 401
Power Service Module, 118
Fan, 302
Port card, 510

For panel E, the first testing sequence was as follows:

| | | | |
|---|---|---|---|
| | Elapsed | Done | |
| Slot Location Task | Time | Correctly | |
| Panel “E” (Switch Side) | (Seconds) | (✓or X) | Comments |

Switch Card, 606
Power Service Module, 806
Switch Card, 601
Power Service Module, 801
Power Service Module 804
Fan, 701
Power Service Module, 807
Switch Card. 604
Switch Card, 602
Power Service Module, 811
Fan, 702

As indicated in the table, the speed at which the participants were able to locate the slots and their accuracy were measured. The results of the testing follow:

| Port Side, all types combined | | | | | |
|---|---|---|---|---|---|
| Total Observations: | 80 | | | | |
| | FAN | PSM | PORT | SC | RSP |
| NUMBER OF CASES | 63 | 80 | 64 | 16 | 32 |
| MINIMUM | 0.51 | 0.47 | 0.51 | 0.41 | 1 |
| MAXIMUM | 8.27 | 4.73 | 7.38 | 3.17 | 10.44 |
| RANGE | 7.76 | 4.26 | 6.87 | 2.76 | 9.44 |
| MEAN | 1.694 | 2.16 | 2.38 | 1.686 | 2.371 |
| VARIANCE | 1.483 | 0.672 | 1.609 | 0.632 | 2.98 |
| STANDARD DEV | 1.218 | 0.82 | 1.269 | 0.795 | 1.726 |
| STANDARD ERROR | 0.153 | 0.92 | 0.159 | 0.199 | 0.305 |
| SKEWNESS (G1) | 2.949 | 0.649 | 1.785 | 0.271 | 3.316 |
| KURTOSIS (G2) | 12.123 | 0.809 | 4.241 | −0.844 | 13.062 |
| SUM | 106.71 | 172.76 | 152.32 | 26.98 | 75.87 |
| C.V. | 0.719 | 0.38 | 0.533 | 0.472 | 0.728 |
| MEDIAN | 1.3 | 2.1 | 2.115 | 1.645 | 1.865 |

| Switch Side, all variables together | | | |
|---|---|---|---|
| Total Observations: | 64 | | |
| | FAN | PSM | SWITCHES |
| N OF CASES | 32 | 64 | 64 |
| MINIMUM | 0.51 | 0.93 | 0.68 |
| MAXIMUM | 2.94 | 4.62 | 3 |
| RANGE | 2.43 | 3.69 | 2.32 |
| MEAN | 1.417 | 1.936 | 1.551 |
| VARIANCE | 0.364 | 0.599 | 0.282 |
| STANDARD DEV | 0.603 | 0.774 | 0.531 |
| STANDARD ERROR | 0.107 | 0.097 | 0.066 |
| SKEWNESS (G1) | 0.715 | 1.043 | 0.681 |
| KURTOSIS (G2) | 0.048 | 1.187 | 0.269 |
| SUM | 45.35 | 123.9 | 99.26 |
| C.V. | 0.426 | 0.4 | 0.342 |
| MEDIAN | 1.335 | 1.875 | 1.47 |

It will be understood by those skilled in the art that although the error prevention and pathfinding apparatus and method have been described in relation to an optical cross-connect platform, the concept is applicable to any communications platform containing functionally disparate and interconnected components where the need for speedy fault isolation exists while ensuring that the potential for technician error is minimized. These other communication platforms are also meant to be included within the spirit of the invention.

We claim:

1. An optical cross-connect platform comprising:
a. power service modules;
b. shelf controller cards;
c. fans;
d. routing, synchronization and protection modules; and
e. port cards;
wherein a selected one of the power service modules is associated with a selected one of the shelf controller cards, fans, routing, synchronization and protection modules or port cards;
and wherein the power service modules, shelf controller cards, fans, routing, synchronization and protection modules and port cards are co-located to form functional groups;
and wherein each power service module and its associated shelf controller card, fan, routing, synchronization and protection module or port card share at least one identifier.

2. The optical cross-connect platform of claim 1 wherein the at least one identifier comprises an alpha identifier, a numeric identifier or a colour identifier.

3. The optical cross-connect platform of claim 1 wherein each of the power service modules, shelf controller cards, fans, routing, synchronization and protection modules and port cards within a functional group are provided with a label associated with the functional group.

4. The optical cross-connect platform of claim 1 wherein the power service modules are further divided into sub-groups, each subgroup associated with the functional groups of the shelf controller cards, fans, routing, synchronization and protection modules and port cards; and wherein each subgroup and its associated functional group are assigned a colour identifier.

5. The optical cross-connect platform of claim 1 further comprising a port side and a switch side, wherein elements (a) to (e) are contained on the port side and the switch side comprises:
a. power service modules;
b. fans; and
c. switch cards;
wherein a selected one of the power service modules is associated with a selected one of the fans or switch cards;
and wherein the power service modules, fans and switch cards are co-located to form functional groups;
and wherein each power service module and its associated fan or switch card share at least one identifier.

6. In an optical cross-connect platform comprising power service modules, shelf controller cards, fans, routing, synchronization and protection modules and port cards, a method of providing error prevention and pathfinding comprising:
a. connecting a selected one of the power service modules to a selected one of the shelf controller cards, fans, routing, synchronization and protection modules or port cards;
b. grouping the power service modules, shelf controller cards, fans, routing, synchronization and protection modules and port cards into co-located functional groups;
c. assigning each power service module and its associated shelf controller card, fan, routing, synchronization and protection module or port card at least one common identifier; and
d. using the at least one common identifier, correlating a selected one of the shelf controller cards, fans, routing, synchronization and protection modules or port cards with its associated power service module.

7. The method of claim 6 wherein the at least one identifier comprises an alpha identifier, a numeric identifier or a colour identifier.

8. The method of claim 6 wherein each of the power service modules, shelf controller cards, fans, routing, synchronization and protection modules and port cards within a functional group are provided with a label associated with the functional group.

9. The method of claim 6 wherein the power service modules are further divided into sub-groups, each subgroup associated with the functional groups of the shelf controller cards, fans, routing, synchronization and protection modules and port cards; and wherein each subgroup and its associated functional group are assigned a colour identifier

10. In an optical cross-connect platform comprising power service modules, shelf controller cards, fans, routing, synchronization and protection modules and port cards, a method of providing error prevention and pathfinding comprising:
a. connecting a selected one of the power service modules to a selected one of the shelf controller cards, fans, routing, synchronization and protection modules or port cards;
b. grouping the power service modules, shelf controller cards, fans, routing, synchronization and protection modules and port cards into co-located functional groups;
c. assigning each power service module and its associated shelf controller card, fan, routing, synchronization and protection module or port card at least one common identifier; and
d. using the at least one common identifier, locating a selected one of the power service modules, shelf controller cards, fans, routing, synchronization and protection modules or port cards with its associated power supply module.

11. A method of error detection and pathfinding in an optical cross-connect platform, the cross-connect comprising power service modules, shelf controller cards, fans, routing, synchronization and protection modules and port cards, wherein a selected one of the power service modules is associated with a selected one of the shelf controller cards, fans, routing, synchronization and protection modules or port cards, and wherein the power service modules, shelf controller cards, fans, routing, synchronization and protection modules and port cards are co-located to form functional groups; and wherein each power service module and its associated shelf controller card, fan, routing, synchronization and protection module or port card share at least one identifier, the method comprising:
locating a selected one of the shelf controller cards, fans, routing, synchronization and protection modules or port cards in less than 3 seconds.
